(19) United States
(12) Patent Application Publication
(10) Pub. No.: US 2002/0041111 A1
(43) Pub. Date: Apr. 11, 2002

(54) Devices and methods relating to blocking wind in the cockpit of a convertible automobile

(75) Inventor: Timothy J. Schmitt, North Bend, WA (US)

Correspondence Address: Joshua king, Suite 350, 155-108th Avenue NE, Bellevue, WA, 98004-5901, US

(73) Assignee: TopDown, Inc.

(21) Appl. No.: 10/000,702

(22) Filed: Nov. 14, 2001

Related U.S. Application Data
(60) Provisional application No. 60/176,067, filed on Jan. 14, 2000.

(51) Int. Cl. B62D 35/00

(52) U.S. Cl. 296/180.5

(57) ABSTRACT

Apparatus and methods related to a windblocker sized to fit under a convertible roof of the convertible automobile when the convertible roof is up. The windblocker comprises a substantially transparent, substantially planar main pane sized to extend substantially across the cockpit behind at least two seats of the cockpit and at least two retractable winglets disposed on either side of the main pane that are movably attached to project from the side of the main pane when in an extended position and to extend inwardly from the side of the main pane when in a retracted position. Also, at least two opposing brackets comprising an attachment portion able to securely attach the opposing brackets to the cockpit behind the seats and a receiving portion, such as two opposing slots, sized to releasably and securely receive the main pane.

### CROSS-REFERENCE TO RELATED APPLICATIONS

The present application claims priority from U.S. provisional patent application No. 60/176,067, filed Jan. 14, 2000.

### FIELD OF THE INVENTION

The field of the present invention is blocking wind in the cockpit of a convertible automobile.

### BACKGROUND OF THE INVENTION

Driving a convertible automobile with the top down can be one of most enjoyable ways to enjoy a drive in the country. However, particularly for extended drives, the wind turbulence created in the cockpit of the car can be distracting and bothersome. A variety of solutions have been proposed to reduce the turbulence in the cockpit but all have disadvantages, for example because the windscreen may be directed to a rumble seat and not the cockpit, the wind screen may not be adequately sized or shaped to adequately block the air coming into the car, or the wind screen must be removed whenever the top (the hard top or the soft top) is put up. See, e.g., U.S. Pat. Nos. 1,369,741, 1,538,333, 1,817,577, 1,846,957, 1,901,329, 2,012,541, 2,040,624, 2,047,941, 2,573,789, 2,641,502, 2,765,191, 4,767,147, 4,838,604, 4,850,637, 5,024,481, 5,195,799, 5,253,916, 5,318,337, 5,702,150, 5,746,472, 5,791,725, 5,899,521.

Thus, there has gone and met the need for a windblocker adequately sized to protect the cockpit of the car from the bulk of the wind turbulence created from driving at high speed. The present invention provides these and other advantages as discussed below.

### SUMMARY OF THE INVENTION

The present invention provides a windblocker for a convertible automobile, or other vehicle, to reduce wind turbulence in the cockpit, which is the seating area of the car containing the driver. The windblocker is located behind the seats in the cockpit and is preferably sized to fit under the convertible roof (either soft top or hard top) when it is up. Preferably, the windblocker can be removed when desired from its location behind the seats. The windblocker comprises a main pane plus at least two winglets disposed on either side of the main pane, which winglets can be either folded in (for example when the top is up) or extended either outwardly/forwardly of the main pain to extend the reach of the windblocker and to close off gaps between the main pain and the seats or side windows of the cockpit. The provision of such a windblocker blocks a significant portion of the wind to significantly to reduce the air turbulence in the cockpit while allowing the user to move the top up and down or on and off without interference from the windblocker, and without requiring the user to remove the windblocker from its location behind the seats.

In one aspect, the present invention provides a windblocker to protect a cockpit of a convertible automobile to reduce wind turbulence in the cockpit. The windblocker preferably fits under a convertible roof of the convertible automobile when the convertible roof is up. The windblocker comprises a substantially planar main pane sized to extend substantially across the cockpit behind at least two seats of the cockpit and at least two retractable winglets disposed on either side of the main pane, wherein the winglets are movably attached to project from the side of the main pane when in an extended position and to extend substantially inwardly from the side of the main pane when in a retracted position. In some embodiments the windblocker is substantially transparent, and the winglets can be movably attached to the main pane by tension hinges capable of maintaining the winglets in a plurality of preferred positions including maintaining the winglets in the extended position in winds in excess of about 100 mph.

The plurality of preferred positions can consist essentially of a) at least one of a first position wherein each winglet is maintained projecting substantially outwardly from and coplanar with the main pane and a second position wherein each winglet projects substantially forwardly from the main pane, and b) a third position wherein each winglet is folded substantially in and near to the main pane. In some embodiments the plurality of preferred positions consists essentially of the first and third positions or the second and third positions. The tension hinges can urge the winglets into the plurality of preferred positions. The level of tension in the hinges can be controllably variable.

In another aspect, the present invention provides a windblocking system to protect a cockpit of a convertible automobile to reduce wind turbulence in the cockpit and sized to fit under a convertible roof of the convertible automobile when the convertible roof is up. The windblocking system comprises a windblocker, and at least two opposing brackets comprising an attachment portion able to securely attach the opposing brackets to the cockpit behind the seats and a receiving portion sized to releasably and securely receive the main pane. In some embodiments the attachment portions of the opposing brackets comprise bolt holes and the receiving portions comprise opposed receiving slots sized to slidably receive corresponding lower outer edges of the main pane. The windblocking system can further comprise a car comprising the opposing brackets attached behind the seats of the cockpit, and the windblocker can be in the opposing brackets.

In other aspects, the present invention provides methods relating to block wind in a cockpit of the convertible automobile to reduce wind turbulence in the cockpit. The methods include methods of making and preparing a windblocker as described herein, and also include placing a windblocker as described herein in a suitable location behind the seats in the cockpit. In some embodiments, the methods comprise placing the windblocker in a suitable location behind the seats in the cockpit by removably attaching the windblocker to at least two opposing brackets disposed behind at least two seats of the cockpit. In some embodiments the attaching comprises sliding lower outer edges of the main pane into corresponding receiving slots in the opposing brackets, or moving the winglets from the extended position to the retracted position or from the retracted position to the extended position.

In some embodiments the methods farther comprise closing or opening a soft convertible roof without removing the windblocker. The methods can comprise removing the windblocker from the cockpit, for example from the opposing brackets.

In further aspects, the present invention provides methods of blocking wind in a cockpit of a convertible automobile to reduce wind turbulence in the cockpit, comprising driving top down in a convertible automobile that comprises the windblocker disposed behind at least two seats of the cockpit. Preferably, the winglets are in the extended position. The methods can further comprise additionally driving with a roof of the convertible automobile closed and the winglets in the retracted position.

In still further aspects, the present invention provides a windblocking system to protect a cockpit of a convertible automobile to reduce wind turbulence in the cockpit and sized to fit under a convertible roof of the convertible automobile when the convertible roof is up, the windblocking system comprising a means for blocking wind comprising a main pane and at least two retractable winglets movably attached to either side of the main pane, and at least two means for securely attaching the means for blocking wind to the cockpit behind the seats. The means for securely attaching can further comprise means for releasably attaching the means for blocking wind to the cockpit.

In still other aspects, the present invention provides methods of blocking wind in a cockpit of a convertible automobile to reduce wind turbulence in the cockpit, comprising a step of driving top down in a convertible automobile that comprises a means for blocking wind disposed behind seats in the cockpit wherein the means for blocking wind comprises a main pane and at least two retractable winglets movably attached to either side of the main pane. The methods can further comprise a step of additionally driving with a roof of the convertible automobile closed with the means for blocking wind in position in the cockpit.

In yet other aspects, the present invention provides a kit comprising a windblocking system to protect a cockpit of a convertible automobile to reduce wind turbulence in the cockpit. The kit can comprise a windblocker as described herein and an attachment system such as at least two opposing brackets comprising an attachment portion able to securely attach the opposing brackets to the cockpit behind the seats and a receiving portion sized to releasably and securely receive the main pane. The kit can further comprise a storage cover sized to sized to substantially encase the windblocker when the windblocker is removed from the cockpit.

These and other aspects, features and embodiments of the present invention are set forth within this application, including the following Detailed Description and attached drawings. The present invention comprises multiple aspects, features and embodiments; unless expressly stated otherwise or clear from the context, all such multiple aspects, features and embodiments can be combined and permuted in any desired manner. In addition, various references are set forth herein, including in the Cross-Reference To Related Applications, that describe in more detail certain compositions, apparatus, methods and other information; all such references are incorporated herein by reference in their entirety and for all their teachings and disclosures, regardless of where they may appear in this application.

### BRIEF DESCRIPTION OF THE DRAWINGS

FIG. 1 is a front plan view of a windblocker according to the present invention.

FIG. 2 is a top side perspective view of a windblocker according to the present invention in place behind the driver and passenger seats of the cockpit of a convertible automobile.

FIGS. 3a and 3b schematically depict the wind turbulence in the cockpit with and without the windblocker in place.

FIG. 4 is a side plan view of a bracket to retain the windblocker in place on the side of the aft compartment of the cockpit of the convertible automobile.

FIG. 5 is similar to FIG. 4 with a windblocker in place in the bracket.

### DETAILED DESCRIPTION OF THE INVENTION

The present invention provides a windblocker that reduces wind turbulence in the cockpit of a convertible automobile. The windblocker is sized to fit under the convertible's roof when it is up. The windblocker typically has a main pane and at least two winglets at the side of the main pane. The winglet(s) can be either folded in (for example when the top is up or for storage) or extended outwardly and/or forwardly of the main pain to extend the reach of the windblocker or close off gaps between the main pain and the door windows of the cockpit. Thus, the windblocker blocks a significant portion of the wind while allowing the user to move the top-up and down or on and off without removing the windblocker from behind the seats. In addition, in a preferred embodiment the windblocker allows the user to completely remove the windblocker from the cockpit area, for example during the winter when the hard top will be on the car for an extended period.

The following paragraphs provide definitions and descriptions of some of the terms used herein. All terms used herein, including those specifically described below in this section, are used in accordance with their ordinary meanings unless the context or definition indicates otherwise. Also unless indicated otherwise, except within the claims, the use of “or” includes “and” and vice-versa. Non-limiting terms are not to be construed as limiting unless expressly stated (for example, “including” means “including without limitation” unless expressly stated otherwise).

The terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

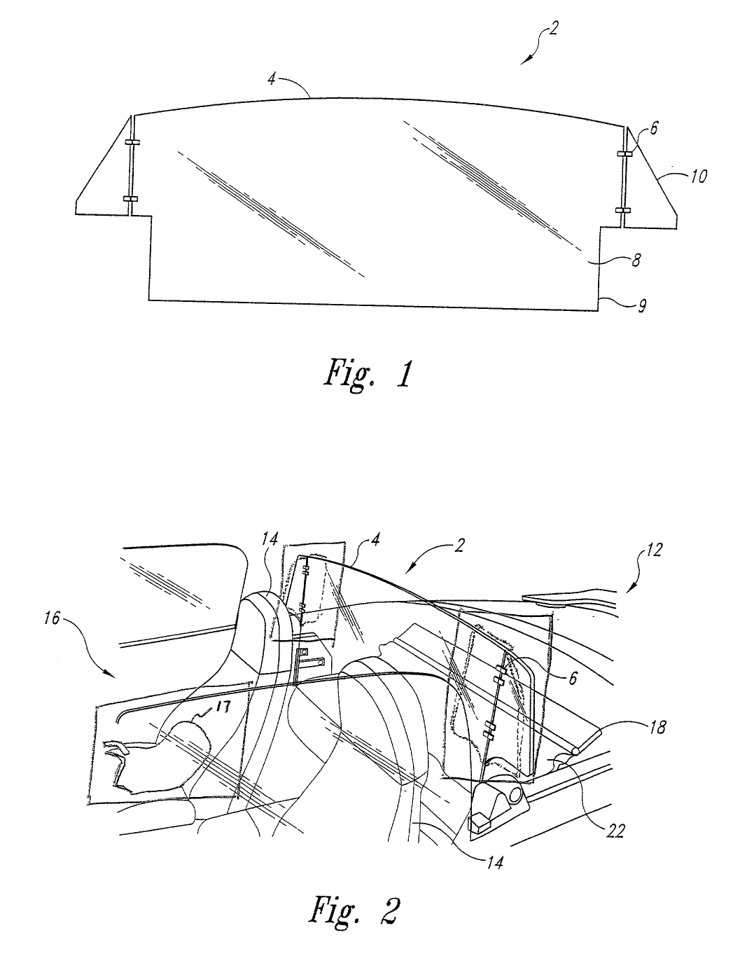

Turning to the Figures, FIG. 1 depicts a windblocker 2 having a main pane 4 and winglets 10. The main pane 4 and winglets 10 of windblocker 2 preferably comprise at least one substantially transparent material such as clear or smoked glass, plastic such as acrylic or Lexan™, or screen made of a material such as metal or plastic. In an alternative embodiment, the windblocker can comprise a non-transparent material, such as window screening, cloth, or mesh. The main pane can also be made of either rigid materials, such as acrylic or soft materials, such as cloth. If soft materials are used, then the windblocker further comprises structure that maintains the windblocker in a desired shape, such as a frame or clips that bind the soft windblocker to desired external structures such as the sides of the aft compartment of the cockpit or the seats. Substantially transparent indicates that a driver can see through the windblocker adequately to be able to view items through the windblocker, typically other traffic in the lanes adjacent to or behind the driver. If desired, the windblocker 2 can be coated with one or more coatings to provide UV resistance, filter sunlight, enhance the attractiveness, or even to provide unusual colorings, such as metallic-based filter coatings that provide rainbow-type effects.

The main pane 4 is substantially planar which means that the main pane 4 can be a flat pane, as in the embodiment shown in FIGS. 1 to 5, or the main pane 4 can be curved slightly in any of forward, backward, up or down directions, for example to provide a substantially cylindrical, toric or spherical curvature. The winglets 10 may be likewise curved if desired. The main pane 4 is sized to extend substantially across the cockpit behind at least two seats of the cockpit, for example from one interior wall to another of the aft compartment of the cockpit, and the winglets 10 extend the reach of the main pane so that the windblocker is more effective in blocking the wind turbulence in the cockpit. The windblocker 2 comprises a base 8, which is a part of main pane 4 in the embodiment in FIG. 1. The base 8 provides structure to maintain the windblocker, via lower outer edge 9 of main pane 4 in the embodiment shown, in place at a desired position behind the seats in the cockpit.

As depicted, the winglets 10 are substantially triangular, but other configurations are also possible, such as trapezoidal. The winglets 10 are movably attached to the main pane 4 so that winglets 10 are retractable, which means that they can be moved back and forth from their extended position to a retracted position. In the retracted position, the winglets 10 extend substantially inwardly from the outer edge and near to the main pane 4 such that the winglets 10 do not interfere with a convertible roof of the car. The roof can be either a soft top or a hard top; when the roof is “up,” the roof is closed or put on the car (for example where the roof is a hard top) and when the roof is down, the roof is open or not on the car. When the winglets 10 are in the extended position, they project away from the main pane 4. Projecting from the side of the main pane 4 includes extending directly outwardly in a substantially co-planar direction from the main pane 4 to extending forwardly from the main pane 4 toward to the seats of the car. Preferably, the winglets 10 are capable of being placed in a plurality of preferred positions at the discretion and desire of the user.

In the embodiment shown in FIG. 1, the winglets 10 are movably attached to main pane 4 via tension hinges 6 capable of maintaining the winglets 10 in the extended position in winds in excess of about 100 mph (e.g., in speeds up to 60 mph or more, even in a head wind of up to 40 mph). In certain embodiments, the tension hinges 6 urge the winglets 10 into one or more preferred positions. For example, each winglet 10 can be disposed in a first position that projects substantially outwardly from and co-planar with the main pane 4, a second position wherein each winglet 10 is projecting substantially forwardly from the main pain 4, and a third position wherein the winglet 10 is retracted and is substantially folded in and near to the main pane 4. The hinges can comprise a controllably variable level of tension, which indicates that the tension holding the hinges in a certain position or urging the hinges into a desired position can be varied to suit the needs of a user, such as variations in anticipated driving conditions.

Turning to FIG. 2, windblocker 2 is depicted in place in the cockpit 16 of a convertible automobile 12. As depicted, the cockpit 16 comprises two seats 14. In alternative embodiments, the cockpit may comprise four seats. The cockpit contains the driver's seat and passenger's seats adjacent to or behind the driver within a single seating area, but does not include seats in any additional seating area such as a rumble seat or tonneau seat, which means an additional seating area contained completely behind the cockpit. The windblocker 2 is disposed behind the seats 14 in the cockpit 16. In the embodiment depicted in FIG. 2, the windblocker 2 is disposed in an aft compartment 22. The compartment can be adjacent to, or designed to hold, convertible roof 18 (which roof is in the down position in the Figure).

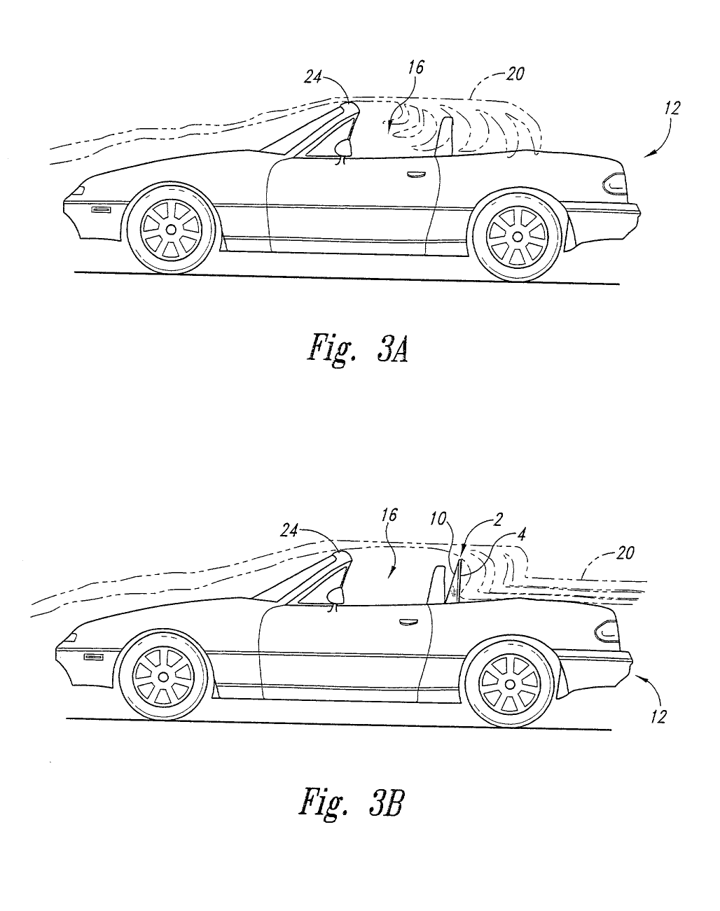

FIGS. 3a and 3b depicts a schematic view of wind turbulence 20 in the cockpit 16 of a convertible automobile 12, both with (FIG. 3a) and without (FIG. 3b) windblocker 2. As indicated in FIGS. 3a and 3b, the wind passes over windshield 24, which creates wind turbulence 20 that is sucked into the cockpit because the cockpit represents a relatively low pressure area compared to the air passing over the windshield 24 and cockpit area 16. This low pressure is the reason why persons riding in the cockpit have their hair blown forward as they are driving, i.e., in same direction as the motion of the car, instead of backwards as would otherwise be expected.

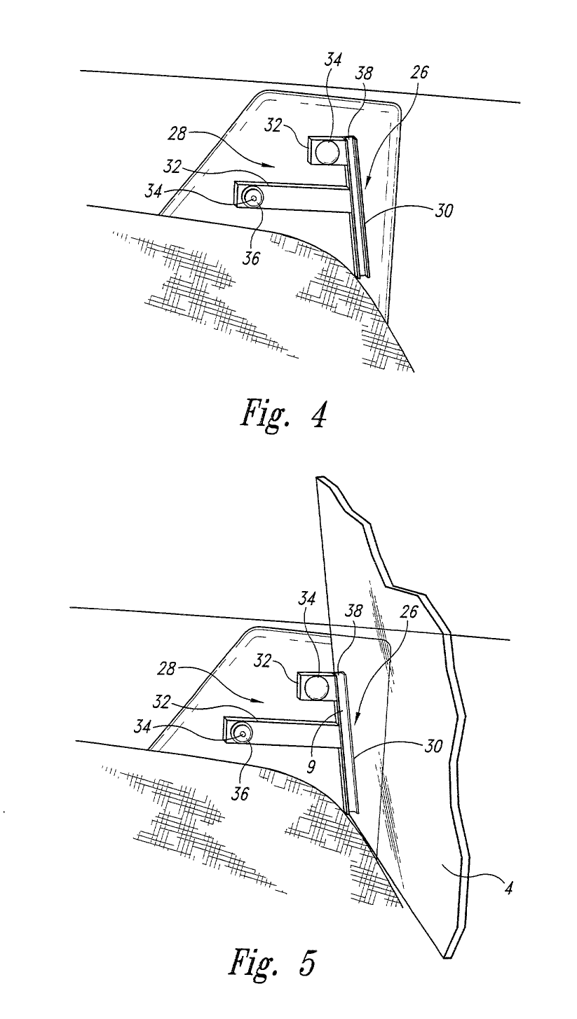

FIG. 4 depicts a bracket 26 that is part of a wind blocking system comprising windblocker 2 and at least two opposing brackets 26, of which only one bracket 26 is shown in FIG. 4. Bracket 26 comprises an attachment portion 28 able to securely attach bracket 26 to the cockpit and receiving portion 30 sized to receive windblocker 2. Attachment portion 28, in the embodiment shown, comprises two legs 32 comprising bolt holes (not shown) through which bolts 34 are passed. Nut 36 secures the bolt 34 in place. Alternative approaches of securing the bracket 26 to the cockpit behind the seats would also be suitable, for example the use of screws, glues, or removable devices such as clips or Velcro strapping. In addition, the brackets can be formed directly in the sides of the aft compartment or other suitable location of the cockpit, for example during the manufacture of the cockpit. Although a single bracket 26 could be used under the windblocker 2, in a preferred embodiment the system comprises two opposing brackets to be attached to either side of the aft compartment 22 of cockpit 16. Additionally, although the brackets can be designed to retain windblocker 2 permanently, the embodiment depicted in the Figures permits the receiving portion 30 of bracket 26 to releasably and securely retain the windblocker 2.

In FIGS. 4 and 5, windblocker 2 is retained in corresponding opposed receiving slots 38 (only one of which is shown) that are each sized to receive a lower outer edge 9 of the main pane 4. FIGS. 4 and 5 depicts one of the opposing brackets 26 in place in the cockpit 16 of the convertible automobile 12, and FIG. 5 depicts the lower outer edge 9 of main pane 4 in place in slot 38 of receiving portion 30.

In additional aspects, the present invention provides methods relating to blocking wind in the cockpit of a convertible automobile or other vehicle. In one embodiment, the present invention provides methods of reducing the wind turbulence by inserting a windblocker having the characteristics claimed herein behind at least two seats in the cockpit. Preferably, the method comprises removably attaching the windblocker to at least two opposing brackets exposed in the cockpit, for example by sliding the outer lower edges of main the pane of the windblocker into corresponding receiving slots in opposing brackets. In addition, the methods can further comprise moving the winglets from the extended position to the retracted position and vice-versa. In addition, if desired, the methods can further comprise closing or opening a soft or hard convertible roof without removing the windblocker. The methods further comprise, if desired, removing the windblocker from its location behind the seats of the cockpit.

In another embodiment, the methods of the present invention provide for driving a convertible automobile comprising a windblocker having the characteristics claimed herein disposed behind the seats in the cockpit of the convertible automobile. Preferably, the methods comprise driving with the winglets projecting in an extended position from one or both sides of the main pane of the windblocker. Alternatively, the method can comprise driving with the roof of the convertible automobile closed in the winglets in the retracted position.

In still other aspects, the present invention comprises kits comprising a windblocker having the characteristics described herein and one or more brackets sized to be placed in a desirable position in the cockpit, and to hold the windblocker in a corresponding desired position. In a preferred embodiment, the kits can further comprise a removable storage cover able to hold the windblocker when it is not in place in the cockpit.

From the foregoing, it will be appreciated that, although specific embodiments of the invention have been described herein for purposes of illustration, various modifications may be made without deviating from the spirit and scope of the invention. Accordingly, the invention includes all permutations and combinations of the subject matter set forth herein and is not limited except as by the appended claims.

What is claimed is:

1. A windblocker to protect a cockpit of a convertible automobile to reduce wind turbulence in the cockpit and to fit under a convertible roof of the convertible automobile when the convertible roof is up, the windblocker comprising a substantially planar main pane sized to extend substantially across the cockpit behind at least two seats of the cockpit and at least two retractable winglets disposed on either side of the main pane, wherein the winglets are movably attached to project from the side of the main pane when in an extended position and to extend substantially inwardly from the side of the main pane when in a retracted position.

2. The windblocker of claim 1 wherein the windblocker is substantially transparent.

3. The windblocker of claim 1 wherein the winglets are movably attached to the main pane by tension hinges capable of maintaining the winglets in a plurality of preferred positions including maintaining the winglets in the extended position in winds in excess of about 100 mph.

4. The windblocker of claim 3 wherein the plurality of preferred positions consist essentially of a) at least one of a first position wherein each winglet is maintained projecting substantially outwardly from and co-planar with the main pane and a second position wherein each winglet projects substantially forwardly from the main pane, and b) a third position wherein each winglet is folded substantially in and near to the main pane.

5. The windblocker of claim 4 wherein the plurality of preferred positions consists essentially of the first position and the third position.

6. The windblocker of any one of claims 3 to 5 wherein the tension hinges urge the winglets into the plurality of preferred positions.

7. The windblocker of claim 6 wherein a level of tension in the hinges that urge the winglets into the preferred positions and maintains the winglets in the preferred positions is controllably variable.

8. A windblocking system to protect a cockpit of a convertible automobile to reduce wind turbulence in the cockpit and sized to fit under a convertible roof of the convertible automobile when the convertible roof is up, the windblocking system comprising a windblocker comprising a substantially planar main pane sized to extend substantially across the cockpit behind at least two seats of the cockpit and at least two retractable winglets disposed on either side of the main pane, wherein the winglets are movably attached to project from the side of the main pane when in an extended position and to extend inwardly from the side of the main pane when in a retracted position, and at least two opposing brackets comprising an attachment portion able to securely attach the opposing brackets to the cockpit behind the seats and a receiving portion sized to releasably and securely receive the main pane.

9. The windblocking system of claim 8 wherein the windblocker is substantially transparent.

10. The windblocking system of claim 8 wherein the attachment portions of the opposing brackets comprise bolt holes and the receiving portions comprise opposed receiving slots sized to slidably receive corresponding lower outer edges of the main pane.

11. The windblocking system of any one of claims 8 to 10 wherein the winglets are movably attached to the main pane by tension hinges comprising a controllably variable tension level and capable of maintaining the winglets in a plurality of preferred positions including maintaining the winglets in the extended position in winds in excess of about 100 mph.

12. The windblocking system of claim 11 wherein the plurality of preferred positions consists essentially of a) at least one of a first position wherein each winglet is maintained projecting substantially outwardly from and co-planar with the main pane and a second position wherein each winglet is projecting substantially outwardly from and forward from the main pane, and b) a third position wherein each winglet is substantially folded in and near to the main pane.

13. The windblocking system of claim 10 wherein the system further comprises a car comprising the opposing brackets attached behind the seats of the cockpit and the windblocker is retained within the opposing brackets.

14. A method of preparing a convertible automobile to block wind in a cockpit of the convertible automobile to reduce wind turbulence in the cockpit, comprising removably attaching a windblocker to at least two opposing brackets disposed behind at least two seats of the cockpit, the windblocker comprising a substantially planar main pane sized to extend substantially across the cockpit and at least two retractable winglets disposed on either side of the main pane, wherein the winglets are movably attached to project from the side of the main pane when in an extended position and to extend inwardly from the side of the main pane when in a retracted position.

15. The method of claim 14 wherein the attaching comprises sliding lower outer edges of the main pane into corresponding receiving slots in the opposing brackets.

16. The method of claim 15 wherein the method further comprises moving the winglets from the extended position to the retracted position or from the retracted position to the extended position.

17. The method of claim 16 wherein the method further comprises closing or opening a soft convertible roof without removing the windblocker.

18. The method of claim 16 wherein the method further comprises removing the windblocker from the opposing brackets.

19. A method of blocking wind in a cockpit of a convertible automobile to reduce wind turbulence in the cockpit, comprising driving top down in a convertible automobile that comprises a windblocker disposed behind at least two seats of the cockpit, the windblocker comprising a substantially planar main pane sized to extend substantially across the cockpit and at least two retractable winglets disposed on either side of the main pane, wherein the winglets are movably attached to project from the side of the main pane when in an extended position and to extend inwardly from the side of the main pane when in a retracted position.

20. The method of claim 19 wherein the windblocker is substantially transparent.

21. The method of claim 20 wherein the winglets are in the extended position.

22. The method of claim 20 wherein method further comprises additionally driving with a roof of the convertible automobile closed and the winglets in the retracted position.

23. A windblocking system to protect a cockpit of a convertible automobile to reduce wind turbulence in the cockpit and sized to fit under a convertible roof of the convertible automobile when the convertible roof is up, the windblocking system comprising a means for blocking wind comprising a main pane and at least two retractable winglets movably attached to either side of the main pane, and at least two means for securely attaching the means for blocking wind to the cockpit behind the seats.

24. The windblocking system of claim 23 wherein the means for securely attaching further comprises means for releasably attaching the means for blocking wind to the cockpit.

25. A method of blocking wind in a cockpit of a convertible automobile to reduce wind turbulence in the cockpit, comprising a step of driving top down in a convertible automobile that comprises a means for blocking wind disposed behind seats in the cockpit wherein the means for blocking wind comprises a main pane and at least two retractable winglets movably attached to either side of the main pane.

26. The method of claim 25 wherein method further comprises a step of additionally driving with a roof of the convertible automobile closed with the means for blocking wind in position in the cockpit.

27. A kit comprising a windblocking system to protect a cockpit of a convertible automobile to reduce wind turbulence in the cockpit, the kit comprising
a) a windblocker sized to fit under a convertible roof of the convertible automobile when the convertible roof is up wherein the windblocker comprises a substantially transparent, substantially planar main pane sized to extend substantially across the cockpit behind at least two seats of the cockpit and at least two retractable winglets disposed on either side of the main pane that are movably attached to project from the side of the main pane when in an extended position and to extend inwardly from the side of the main pane when in a retracted position, and
b) at least two opposing brackets comprising an attachment portion able to securely attach the opposing brackets to the cockpit behind the seats and a receiving portion sized to releasably and securely receive the main pane.

28. The kit of claim 27 wherein the kit further comprises a storage cover sized to sized to substantially encase the windblocker when the windblocker is removed from the cockpit.
